(19) United States
(12) Patent Application Publication
(10) Pub. No.: US 2025/0188205 A1
(43) Pub. Date: Jun. 12, 2025

(54) HYBRID PHOTO-COMPOSITE COATING

(71) Applicant: Meta Platforms Technologies, LLC, Menlo Park, CA (US)

(72) Inventors: Alejo Lifschitz Arribio, Redmond, WA (US); Anthony Cong Phan, Redmond, WA (US)

(21) Appl. No.: 18/827,309

(22) Filed: Sep. 6, 2024

Related U.S. Application Data
(60) Provisional application No. 63/607,336, filed on Dec. 7, 2023.

(51) Int. Cl. C08F 20/10; C08K 9/02; C08K 9/04

(52) U.S. Cl. CPC C08F 20/10; C08K 9/02; C08K 9/04; C08K 2201/011

(57) ABSTRACT

A photo-reactive hybrid nanocomposite is disclosed, including a nanoparticle with a high refractive index, an organic resin precursor, and a reagent. The reagent may be a metal oxide-forming photo-reagent that reacts to visible light to form a metal oxide (MOx) and organic radical species.

### CROSS-REFERENCE OF RELATED APPLICATION

This application claims the benefit of U.S. Provisional Application No. 63/607,336, filed on Dec. 7, 2023, which is incorporated herein in its entirety.

### TECHNICAL FIELD

The present disclosure generally relates to optical materials for waveguide components in virtual reality (VR), augmented reality (AR), and mixed reality (MR) devices, and more particularly to a high-refractive index (RI), high Δn photo-patternable material via latent chemistry for recording Volume Bragg Gratings (VBGs) and holographic patterns.

### BACKGROUND

Thick, high-RI coatings of photo-reactive materials where light-excitation leads to a local change in refractive index (RI) can be used to record Volume Bragg Gratings (VBG), holographic patterns with high angular selectivity. These photo-reactive materials can thus be used as Waveguide (WG) components in VR/AR/MR devices, wherein the photo-generated pattern controls the refraction and diffraction efficiency of light as it travels through the coating. The high-RI allows for generation of an AR image with a large Field-of-View. The high thickness of these coatings is key to sustaining high-angular selectivity and thus decreasing optical artifacts, such as rainbows, leakage and other detrimental image quality issues. The higher the Δn and thickness of the sample, the higher the diffraction efficiency of the WG.

In order to increase the efficiency of the WG device while maintaining sufficiently high image quality, there is a need for a photo-reactive coating with a thickness greater than 1000 nm after the photo-electric material is processed. The base refractive index of the coating, i.e., the portion of the film with the higher RI after exposure, should be at least 1.7. The thickness difference between photo-exposed and unexposed areas should be minimized (e.g., <5% of total coating thickness) to prevent surface scattering and diffraction. More specifically, variations in coating thickness along the length of the WG can lead to optical artifacts, such as ghost images, or decreased image quality, such as pupil swim. Furthermore, periodic variation in coating thickness, such as distinct thickness changes in the exposed regions, can act as surface relief gratings capable of undergoing their own diffractive behavior and thus disrupt the functionality of the overall WG system. There should be a large RI contrast (Δn>0.05) between photo-exposed and unexposed areas. To improve WG efficiency, both photo-exposed and unexposed areas should be transparent to visible light after the material is fully processed (i.e., Absorption <0.1%/100 nm). That is, for the coating to allow total internal reflection (TIR) with minimal absorptive losses, the photo-electric material should not be capable of electronic absorption of the light travelling through the material. Exposure should lead to a pattern of chemical or thermal reactivity that only produces a large change in local RI once the material undergoes post-processing. This behavior is referred to as photo-induced latent chemistry. That is, the photo-exposure process itself does not lead to a significant change in RI. Instead, it leaves behind a pattern of reactivity that is exploited in a subsequent step, such as thermal annealing. Photo-induced latent chemistry behavior is particularly important when undergoing photo-exposure via patterns of constructive and destructive interference or when it is critical to achieve nm-scale resolution between photo-exposed and unexposed areas, because generation of a local Δn can itself diffract the light that is used to photo-pattern the material, thereby leading to parasitic grating formation or other aberrations in the diffraction and refraction behavior of the pattern. By de-coupling photo-excitation from Δn formation into two separate processing steps (photo-excitation and post-processing), the photo-reactive material can be exposed for as long as necessary without compromising the Δn pattern quality. Photo-patterning should be possible with visible light, in order to be able to make WG gratings with pitches that interact with visible light using available 2-beam interference exposure equipment.

### SUMMARY

The subject disclosure provides for compositions of matter and methods for nanocomposites. One aspect of the disclosure relates to a photo-reactive hybrid nanocomposite. The nanocomposite may include nanoparticle with a high refractive index, an organic resin precursor, and a reagent. The reagent may be a metal oxide-forming photo-reagent that reacts to visible light to form a metal oxide (MOx) and organic radical species.

Another aspect of the disclosure relates to a method of manufacturing a photo-reactive hybrid nanocomposite. The method may include providing a nanoparticle with a high refractive index. The method may include mixing the nanoparticle with an organic resin precursor. The method may include adding a metal oxide-forming photo-reagent that reacts to visible light to form a metal oxide (MOx) and organic radical species to the mixture. The method may include exposing the mixture to visible light to activate the MOx and resin precursors. The activated precursors may react to form an extended MOx and organic species and partially displace the nanoparticle.

Yet another aspect of the disclosure relates to a photo-reactive hybrid nanocomposite for use in high-efficiency waveguide gratings. The nanocomposite may include a nanoparticle with a high refractive index, an organic resin precursor, and a metal oxide-forming photo-reagent that reacts to visible light to form a metal oxide (MOx) and organic radical species. The nanocomposite may be capable of forming a photo-pattern with a high refractive index contrast (Δn) upon exposure to visible light and subsequent annealing.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a schematic representation of a process for creating a high-refractive index (RI), high angular selectivity photo-patternable material using latent chemistry, according to certain aspects of the disclosure.

FIG. 2 illustrates steps from photo-exposure under a pattern of constructive and destructive interference to the formation of a 2D or 3D photo-pattern of RI variations, according to certain aspects of the disclosure.

FIG. 3 illustrates example solutions including photo-reactive nanocomposite and photo-solgel processes for creating variable RI upon selective photo-activation, according to certain aspects of the disclosure.

FIG. 4 illustrates alternative example solutions such as silver halide development and PTR glass processes for creating local RI gradients within a coating, according to certain aspects of the disclosure.

FIG. 5 illustrates an example solution for a photo-reactive hybrid nanocomposite made of a nanoparticle, a resin precursor, and a metal oxide (MOx) precursor, detailing the process from selective photo-activation to the formation of a high-density MOx within an organic resin matrix, according to certain aspects of the disclosure.

FIG. 6 includes a table that illustrates comparative example 1, showing the components, concentrations, patterning parameters, and resulting optical properties of a photopolymer coating, according to certain aspects of the disclosure.

FIG. 7 includes a table that illustrates comparative examples 2 and 3, detailing the components, concentrations, and optical properties of photo-composite coatings, according to certain aspects of the disclosure.

FIG. 8 includes a table that illustrates working examples 4-9, presenting the components, concentrations, patterning parameters, and resulting optical properties of photo-composite coatings, according to certain aspects of the disclosure.

FIG. 9 includes a table that illustrates working examples 10-11, showing the variations in exposure methodology and their effects on the optical properties of the coatings, according to certain aspects of the disclosure.

FIG. 10 includes a table that illustrates working examples 12-16, presenting the effects of varying component concentrations on the efficiency of the gratings in photo-composite coatings, according to certain aspects of the disclosure.

FIG. 11 includes a table that illustrates working examples 17-18, detailing the impact of nanoparticle functionality on the formation of gratings and the resulting optical properties, according to certain aspects of the disclosure.

FIG. 12 includes a table that illustrates working example 20, showing the results of a high-concentration formulation for a hybrid photo-composite coating, according to certain aspects of the disclosure.

FIG. 13 illustrates an example flow diagram for manufacturing a photo-reactive hybrid nanocomposite, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The illustrative embodiments recognize that there is a need for materials that can be incorporated into WG devices as thick (>1000 nm), high-RI optical coatings, and which react to photo-excitation by creating a pattern of latent chemistry that leads to a large Δn upon post-processing. The materials should be fully transparent in both photo-exposed and nonexposed areas once post-processing is completed, and should result in minimal thickness variations within all areas of the coating.

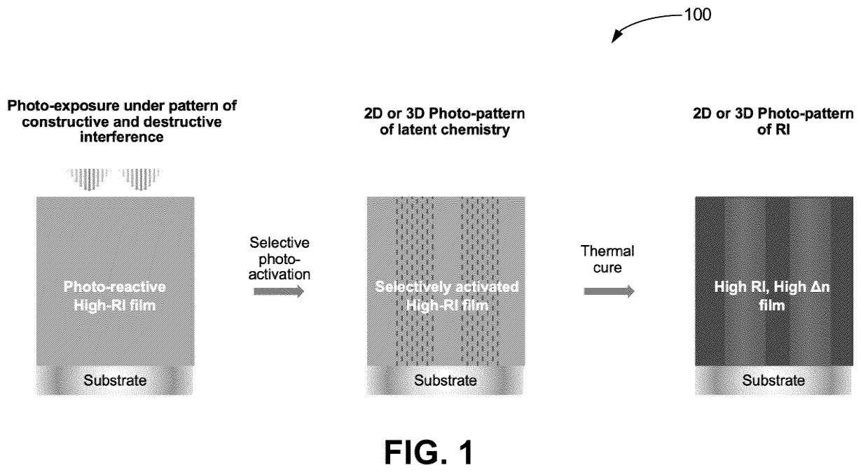

FIG. 1 illustrates a schematic representation 100 of a process for creating a high-refractive index (RI), high angular selectivity photo-patternable material using latent chemistry, according to certain aspects of the disclosure. In order to increase the efficiency of the WG device while maintaining good image quality, some implementations may include a coating thickness >1000 nm after material is processed, and the base refractive index of the coating, i.e., the portion of the film with the higher RI after exposure, to be at least 1.7.

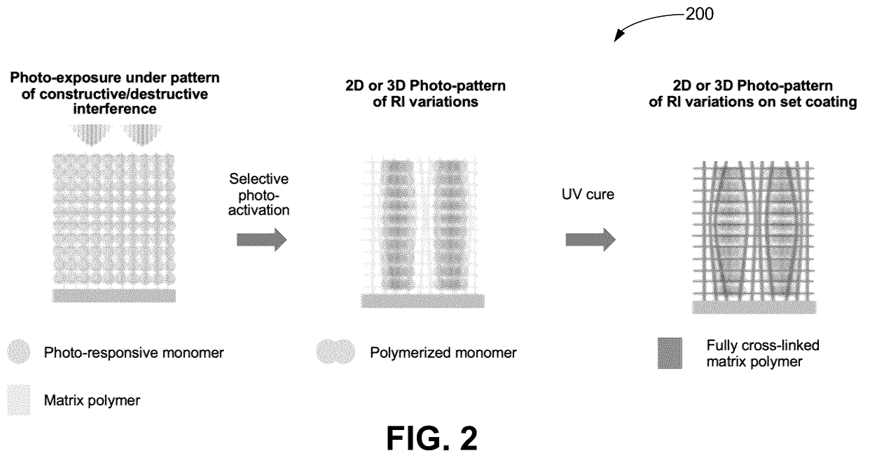

FIG. 2 illustrates steps from photo-exposure 200 under a pattern of constructive and destructive interference to the formation of a 2D or 3D photo-pattern of RI variations, according to certain aspects of the disclosure. Organic photopolymers may be an established materials solution to create coatings with variable RI upon selective photo-exposure, and their application may be common in holographic and VBG WG devices. However, their optical properties and patterning performance may be limited.

The patterning may not occur via latent chemistry. Rather, the pattern may be actively formed during photo-exposure. This may be because photoexcitation causes the photo-reactive monomer or oligomer component to be polymerized. As excitation occurs in specific regions of the film, the monomer may be locally consumed into a growing polymer chain, triggering the displacement of more monomer away from the unexposed areas and depleting them of this component. Since this monomer may typically have a different RI, as compared to the rest of the overall material, the movement of the photo-reactive monomer across the film induced by local photoexcitation may lead to an RI gradient. The material may actively shift local RI as it is photo-excited, meaning that exposure time may be increased at the expense of parasitic feature formation and recording density.

Since these materials may be fully composed of organic components, their base RI may be significantly lower than 1.7. Specifically, the organic nature of these photo-reactive polymers may mean that it is challenging to maintain high flow and diffusability while also increasing the base RI of each component significantly >1.5. That is, increasing RI in organic components may entail incorporating rigid, aromatic, or larger heteroatom moieties that usually reduce flow. Since RI changes may require mobility of the components, the organic photopolymer mixtures may have modest overall RI values.

While photopolymers may be coated with high thicknesses, their efficiency drawback for WG fabrication may include its low Δn. This may be due to the limited diffusion capabilities of the monomer through the polymer matrix, and the relatively low bulk RI difference between the different organic components. Thus, the WG grating Δn may be modest, usually well below <0.05.

Finally, organic materials and polymers may have large coefficients of thermal expansion (CTE) as compared to inorganic substrates that the photopolymer is deposited onto. This CTE mismatch may introduce thermomechanical integration issues that often lead to interfacial failure or deformation of multi-layer components, ultimately resulting in failure of reliability and stress testing for the overall optical device.

Overall, the mechanistic and material limitations in organic photopolymers may mean that they are not compatible with latent chemistry photopatterning, and the base RI and RI variation values may not be increased significantly above >1.6 and >0.05, respectively, without decreasing optical performance and image quality. As a result, there may be a need for new thick, inorganic materials with higher base RI, higher Δn and latent chemistry patterning behavior.

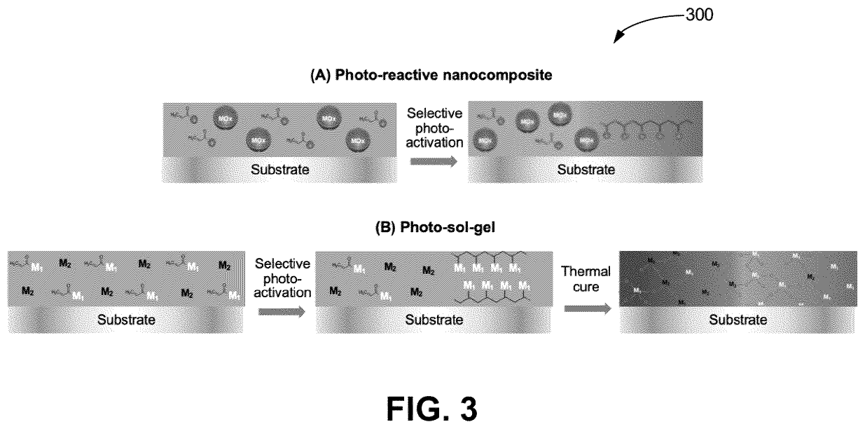

FIG. 3 illustrates example solutions 300 including photo-reactive nanocomposite and photo-solgel processes for creating variable RI upon selective photo-activation, according to certain aspects of the disclosure. Photo-reactive nanocomposites may have been used to increase the base RI of photopolymers (see (A) in FIG. 3). In this case, the overall mechanism to local RI variation may be fundamentally similar, wherein the photo-reactive monomer segregates upon excitation and it displaces the nanoparticle and other organic components as it polymerizes. By increasing the nanoparticle loading, it may be possible to increase the base RI >1.5. However, since the nanoparticles may reduce the ability of the photo-reactive monomer to migrate, and the nanoparticles themselves may require more energy to be displaced, then the Δn is well below 0.01. In addition, the same limitations in photopolymers from lack of latent chemistry formation may be present in photo-reactive nanocomposites.

Solgel coatings may have been used as an alternative inorganic materials class with improved diffusion and reorganization potential. Solgels may include coatings containing metal oxide precursors that progressively condense upon heating by eliminating solvent and organic ligands to finally form a glassy state. The condensation process may be accompanied by a significant reorganization of film microstructure and shrinkage, thus improved diffusion needs to be leveraged against local thickness variations and patterned feature deformation.

Hybrid solgels may be used to create local RI changes by incorporating a photopolymerizable organic ligand that enables a photo-induced segregation behavior similar to that of photopolymers (see (B) in FIG. 3). Thus, the solgel may have similar limitations to photopolymers in terms of limited RI variation, scattering and pattern integrity issues related to the fact that there is no latent chemistry mechanism.

In addition, the photo-induced RI variations demonstrated in these films may be <0.05, since patterning still relies on the photopolymerizable material segregating during excitation. Base RI may be increased via the addition of the inorganic solgel components. But the need to use large amounts of photopolymerizable organic ligands in the hybrid solgel may mean that the base RI values reported in the literature is <1.7 when annealed <300° C. In addition, the increased coating shrinkage may introduce the risk of deforming or blurring the boundaries of the features formed via photo-exposure. As a result of these limitations, hybrid solgels may not be used for creating high efficiency WG gratings via holographic exposure.

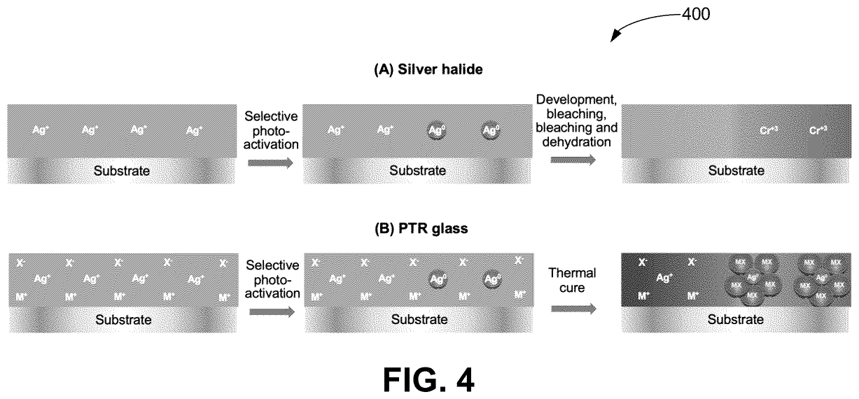

FIG. 4 illustrates alternative example solutions 400 such as silver halide development and PTR glass processes for creating local RI gradients within a coating, according to certain aspects of the disclosure. Gelatin layers sensitized with dichromate or silver halide may be used to create local RI gradients within a coating via latent chemistry, but they may suffer from low ΔRI switchability and stability issues. In the case of dichromated gelatin, photo-induced reduction of Cr^{VI} centers within a hydrated gelatin coating may be used to control local cross-linking of the gelatin scaffold. Through a series of aging and wet post-processing steps, the unreacted Cr^{VI} is removed and the partially reduced Cr in the photo-exposed areas may be fully reduced to Cr^{III}. Once the gelatin is dried, the areas that contain Cr^{III} may show higher densification, while the unexposed areas may be denser or even show micro-voids, thereby creating a pattern of local RI variations within the gelatin layer.

The silver halide process may operate through a related mechanism, wherein Ag⁺ is the photosensitizer that oxidizes the gelatin upon light exposure. Upon removal of soluble Ag⁺ in the non-exposed areas, the Ag clusters may be bleached and replaced by Cr^{III}, which similarly helps to increase the local density of the gelatin.

While both variations of this approach may allow for recording via latent chemistry onto gelatin layers with high transmission and low scattering, they may suffer from the optical and reliability challenges of organic materials. Specifically, the base RI of gelatin may be moderate (˜1.54) and RI variation may be below <0.05. In the case of Ag halide, scattering of the Ag emulsion and the photo-exposed product may introduce image quality issues. In addition, the hygroscopic nature of the gelatin scaffold may require complete encapsulation of the layer to prevent variations in RI or complete erasing of the photo-generated pattern. Thus, application of this material to holographically image WG gratings with high efficiency may be limited.

Photo-thermo-refractive (PTR) glasses may be an inorganic alternative to photopolymer uses in latent chemistry to drive the aggregation of formulation components to generate variations in RI (FIG. 4B). In this case, the material may be a silicate glass containing RI contrast elements, such as Na+ and F−, and doped with photo-reactive species, such as Ag+ and Ce+3. Local photoexcitation may lead to the formation of a pattern of latent chemistry, by creating Ag nanoclusters that serve as nucleation sites for the RI contrast species upon subsequent thermal annealing. Heating at >300° C. may lead to segregation of NaF around the photo-generated nanoclusters. Since NaF may have a lower RI (1.32) than silicate glasses (˜1.45-1.55), the segregation results in a pattern of local RI variations.

While the mechanical and optical stability of the glass may be superior to the photopolymer examples, the need to diffuse the RI contrast components through the denser glass ultimately limits optical properties. Specifically, the high annealing temperatures may mean that the rate of component segregation is in competition with the rate of homogeneous mixing of the overall material. Thus, the formation of the RI variation pattern may be in direct competition with a process that erases the RI pattern and homogenizes optical properties. In addition, since the growth rate of NaF may be higher than the nucleation rate, the increase in RI contrast may occur at the expense of domain formation and potential haze from the domains growing too large. Overall, while PTR glasses may have a distinct latent chemistry photo-patterning mechanism, they may have relatively low base RI values and they are not able to produce VBG or holographic patterns with RI variations above 0.001.

SnO(x)Cl(y) coatings may be formed using a non-hydrolytic solgel approach, wherein the Sn valence and O versus Cl ratio may be controlled by the solgel solvent choice. The coatings may have constant RI values that range from 1.60 to 2.10. The same SnO(x)Cl(y) material class may be used to create coatings with variable RI values. The local RI control may result from gradual changes in solvent type and content in the coating prior to annealing. For example, by increasing the content of isopropanol solvent in portions of the coating, the RI may be reduced to 1.6, whereas other portions enriched with DPGME solvent may have RI values as high as 2.1. The local solvent variations may be achieved via selective deposition techniques such as ink-jet printing. Furthermore, since the final coatings may be made up of inorganic components, their environmental stability, reliability, and integration compatibility with inorganic substrates may be more promising than organic counterparts.

While this material class may appear to strongly respond to slight changes in its chemical environment by shifting its post-anneal composition and RI, those changes in the chemical environment may not be induced via photoexcitation. Some implementations include new materials and processes that allow for recording patterns of RI variations using light, with material base RI>1.6 and RI variations >0.1.

SnO(x)Cl(y) coatings containing a photo-acid generator (PAG) may be photopatterned to produce large changes in local RI. However, solgel coatings may have poor uniformity and mechanical stability when the thickness is increased beyond a critical threshold. For SnO(x)Cl(y) coatings deposited via spin-coating, that threshold may be <600 nm. When the thickness of the coating approaches the threshold, the film may become highly uneven with >10% thickness variations across the material. This variation in thickness may prevent the even recording of RI patterns while keeping an acceptable patterned feature shape. In addition, the thickness variation introduces local variations in the way light transverses the WG, thus decreasing the optical quality of the device.

As SnO(x)Cl(y) coatings deposited via spin-coating approach 600 nm, the coatings may show haze. This may be caused by scattering from grain and crack formation during film annealing, which in turn may be consequences from the inherent shrinking behavior of solgels as they are cured. The shrinking process may cause some build-up of strain in the coating as the solgel compresses at high temperature. In some implementations, the thicker the coatings, the higher the stress build-up may be. Thus, when the stress crosses an upper threshold determined by the specific solgel material properties, the stress may be relieved via crack formation. For optical coatings for WG applications, cracks may be an unacceptable defect that disrupts the flow of light through the device, by decreasing WG efficiency and decreasing image quality.

Thicker SnO(x)Cl(y) coatings may be made via spin-coating by incorporating an organic resin or a nanocomposite containing both a nanoparticle and a photopolymerizable resin monomer. These combinations may allow one to maintain film photo-reactivity while increasing the thickness range for high-quality coatings to 1000 nm. These materials may allow for improved resolution, so that creating WG features in the 200-1000 nm pitch range may be possible. However, photo-patterning in all of these examples may require exposure with UV light, limiting its application in the generation of VBG WG gratings using standard exposure equipment. Some implementations include new materials that may be photo-patterned with visible light (>400 nm), have thicknesses >1000 nm, base RI>1.7, responds to photoexcitation by varying the RI over a large RI window (>0.3RI) and which show Absorption <0.2% in all exposed and unexposed areas.

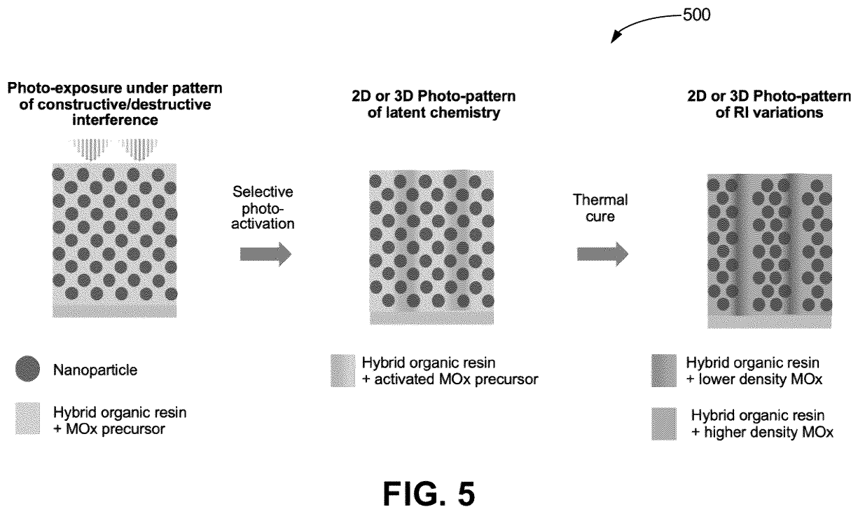

FIG. 5 illustrates an example solution 500 for a photo-reactive hybrid nanocomposite made of a nanoparticle, a resin precursor, and a metal oxide (MOx) precursor, detailing the process from selective photo-activation to the formation of a high-density MOx within an organic resin matrix, according to certain aspects of the disclosure. Some implementations may include a photo-reactive hybrid nanocomposite made of a nanoparticle and an organic resin plus MOx precursor. Selective exposure of this material may lead to activation of the MOx and resin precursors, which may react with each other to form extended MOx and organic species and partially displace the nanoparticles. Thermal anneal may solidify the material, cementing the segregation of the nanoparticle away from the exposed regions and leading to a hybrid MOx+resin matrix surrounding the nanoparticles, wherein the matrix may have a varying MOx and organic resin density depending on whether the local region was photo exposed.

According to some implementations, this photo-patternable material may contain a high-RI nanoparticle, a resin monomer/oligomer, and a metal oxide-forming photo-reagent that reacts to visible light (>400 nm), with one or more of the following specifications:

### Nanoparticle:

The nanoparticle may have an average size <50 nm;
The nanoparticle core may be composed of TiO2, Nb2O5, Ta2O5, ZrO2, HfO2, SnO2, SnO, ZnS, ZnO, or BaTiO3;
The nanoparticle may contain a passivating metal oxide shell composed of ZrO2, HfO2, ZnS, SiO2, Al2O3, ZnS, ZnO, or Ta2O5;
The nanoparticle may be surface passivated with phosphate, siloxane, or silicate species;
The nanoparticle may be surface-treated with organic species with low coordination strength for the metal oxide-forming photo-reagent, thus preventing aggregation or disruption of the photo-reactivity;
The nanoparticle may be surface treated with methacrylate or acrylate containing species; and
The nanoparticles may form a suspension when mixed with the solgel precursor that is stable (does not precipitate) for at least 30 minutes.

Resin Monomer/Oligomer:
Monomer/oligomer may be a small molecule with 1-10 acrylate/methacrylate reactive sites;
Reactive may have photo-generated free-radicals;
High base RI (>1.55);
Viscosity may be between 10000 and 100 cP; and
Boiling point or thermal degradation in <50 μm film <250° C.

### Metal Oxide-Forming Photo-Reagent:

Metal oxide-precursor may contain a metal center decorated with photo- and thermally labile ligands;
Metal center may be Si, Sn or Ge;
Excitation with visible light may lead to ligand scission and release of (1) a metal species that readily forms a metal oxide upon annealing and (2) an organic radical moiety; and
Annealing non-exposed regions at >120° C. may lead to degradation of the ligand environment and formation of a metal oxide.

Unlike other photo-reactive nanocomposites, some implementations may not use a small amount (<1 wt % of non-solvent components) of the photo-reagent as a catalyst to trigger radical polymerization of other components. Instead, some implementations utilize the photo-reagent as a quantitative reactant that is photolyzed or annealed to form a metal oxide network. Thus, it may be used in much higher concentrations, i.e., >20 wt % of non-solvent components, and for the unique purpose of transforming it into an inorganic metal oxide.

This formulation may allow one to maintain a high base RI since it is compatible with high nanoparticle loadings, i.e., >60 wt % of non-solvent components, without leading to cracking or Abs/Haze increase. The reason for the low Absorption may be that the nanoparticles contain a protective shell made of a second metal oxide that prevents thermal yellowing of the high-RI core. Haze may be low since the particles are surface functionalized to prevent aggregation during coating and processing; and since both exposed and non-exposed areas can sustain particle dispersion even after high temperature anneal. That is, the photo-exposed areas may contain a resin precursor and activated MOx precursor that contains the nanoparticles and prevents aggregation. The non-exposed areas may contain non-activated MOx precursors, which may thermally form an MOx network that prevents the nanoparticles from aggregating even after the non-polymerized resin monomer/oligomer is thermally degraded/evaporated.

High RI may result from the resin monomer/oligomer having a high RI (i.e., >1.55) and the metal oxide-forming photo-reagent forms high RI materials after being processed, regardless of whether it is photo-exposed (i.e., RI>1.7 in both cases). Some implementations may allow for high thickness coatings (i.e., >1 μm) since the metal oxide-forming photo-reagent and resin monomer/oligomer provide the mechanical stability for the coating to not fracture or flake off as it is processed. In the absence of both of these components, the large amount of nanoparticle loading may lead to mechanical issues that prevent the formation of an optical-quality coating.

Patterning with visible light may be possible since excitation of the metal centers in the metal oxide-forming photo-reagent leads to release of a low-coordination metal species that readily forms an MOx upon annealing. Both the exposed and non-exposed regions may be transparent to visible light after annealing at >150° C., thereby bleaching the patterned film throughout and allowing the low overall Abs needed to construct high efficiency WG patterns.

Formation of gratings with high Δn may be facilitated by one or more of the following:
The nanoparticles' surface chemistry may allow them to flow and be displaced upon annealing without aggregation;
The non-activated MOx-forming photo-reagent and resin monomer/oligomer in the non-exposed regions may lead to significant evaporation or thermal degradation of organic ligands and components during high-temperature (i.e., >150° C.) anneal, thereby reducing the number of organic species in the non-exposed regions and increasing their RI over the exposed regions;
The exposed regions may contain radical species that trigger the polymerization of resin monomer/oligomers and prevent the thermal degradation/evaporation of organic components upon high temperature (i.e., >150° C.) anneal, thereby increasing the number of organic species in the exposed regions and lowering their RI over the non-exposed regions; and
The MOx-forming photo-reagent may form a rigid MOx network upon photo-exposure, thus leading to the formation of a containment framework within the coating that preserves the resolution of the imaged gratings and prevents the blurring or destruction of these features upon high-temperature annealing.

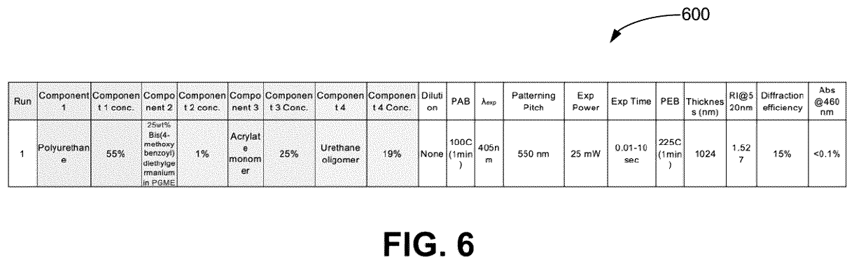

FIG. 6 includes a table 600 that illustrates comparative example 1, showing the components, concentrations, patterning parameters, and resulting optical properties of a photopolymer coating, according to certain aspects of the disclosure. A 1 μm-thick coating of a photopolymer containing a polyurethane matrix, a visible light photo-initiator, a high-RI acrylate monomer and a counter-diffusion agent was deposited onto a transparent substrate. The material was photo-patterned with a 405 nm 2-beam interference source, wherein the angle between the 2 beams led to a pattern of exposure intensity with a 550 nm pitch. The formation of a diffractive pattern was readily apparent as the sample was photo exposed. The coating was then blanket UV-cured to set the film and its optical properties were investigated. The base RI and thickness were determined via ellipsometry, revealing that the organic polymer formulation leads to coating of about 1 μm thickness and a relatively low RI of 1.52 at 520 nm. The efficiency of the gratings was determined by shining a 550 nm laser onto the grating pattern and measuring the intensity of all diffracted beams. This led to a diffraction efficiency of 15%. Finally, the transparency of the sample was determined via transmission and reflection spectroscopy, indicating that the sample transparency decreased as the phosphine oxide concentration increased. No grating formation could be observed via STEM inspection. Finally, the Δn of the gratings was determined by using a laser-based setup that measures diffraction efficiency as a function of polarization, angle of incidence, and wavelength. This relationship was extracted at 630 nm, 520 nm, and 450 nm, and the Δn was calculated by fitting the data to a model that assumes that the grating shape is sinusoidal, and which uses the base RI and thickness derived from the ellipsometry measurement. It was thus found that the Δn of the gratings is <0.05. This comparative example shows that photopolymers based on active photo-segregation of a resin component led to a non-latent chemistry pattern formation with low base RI and low Δn. Thus, a visible light-reactive inorganic material with high base RI and high Δn, and compatible with latent chemistry patterning, is needed.

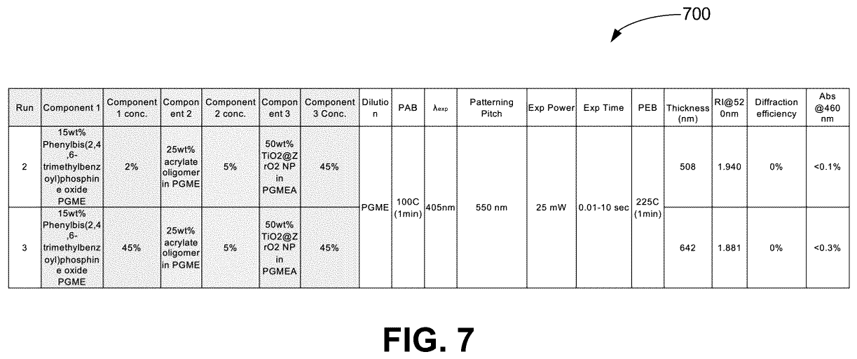

FIG. 7 includes a table 700 that illustrates comparative examples 2 and 3, detailing the components, concentrations, and optical properties of photo-composite coatings, according to certain aspects of the disclosure. Photo-composite coatings were deposited onto a transparent wafer via spin-coating of a suspension containing a core-shell TiO₂@ZrO₂ nanoparticle, an acrylate oligomer, and a phosphine oxide photo-initiator. The phosphine oxide was used at two loadings. One that is representative of typical catalytic loadings, where the concentration is much lower than that of the resin oligomer; and at a high loading that is a point of comparison with the use of MOx-forming photo-reagents in this disclosure. The coatings underwent post-application bake at 100° C. for 1 minute to remove residual solvent. The dried samples were then photo-patterned with a 405 nm 2-beam interference source, wherein the angle between the 2 beams led to a pattern of exposure intensity with a 550 nm pitch. The formation of a diffractive pattern was not readily apparent as the sample was photo exposed. The coating underwent a post-exposure bake of 225° C. for 1 minute to set the film. The base RI and thickness were determined via ellipsometry, revealing that the photo-composite formulation leads to an RI of ˜1.9 at 520 nm. The efficiency of the gratings was determined by shining a 550 nm laser onto the grating pattern and measuring the intensity of all diffracted beams. However, no diffraction efficiency was observed. Finally, the transparency of the sample was determined via transmission and reflection spectroscopy, indicating that the sample was highly transparent, with an Absorption <0.1%. The grating shape was determined by STEM inspection, which showed that the gratings result from segregation of the acrylate materials as it is actively photopolymerized, as evidenced by an increase in film density in the exposed areas following a sinusoidal density distribution. Finally, the Δn of the gratings was determined by using a laser-based setup that measures diffraction efficiency as a function of polarization, angle of incidence, and wavelength. This relationship was extracted at 630 nm, 520 nm, and 450 nm, and the Δn was calculated by fitting the data to a model that assumes that the grating shape is sinusoidal, and which uses the base RI and thickness derived from the ellipsometry measurement. Without any diffraction response of the grants, the Δn was determined to be 0. In other words, no gratings were formed at this pitch. This comparative example shows that a high RI coating can be formed with a photo-composite. However, the lack of a photo-reagent that forms an extended MOx that contains the imaged features results in a lack of resolution necessary to image and retain tight pitch features.

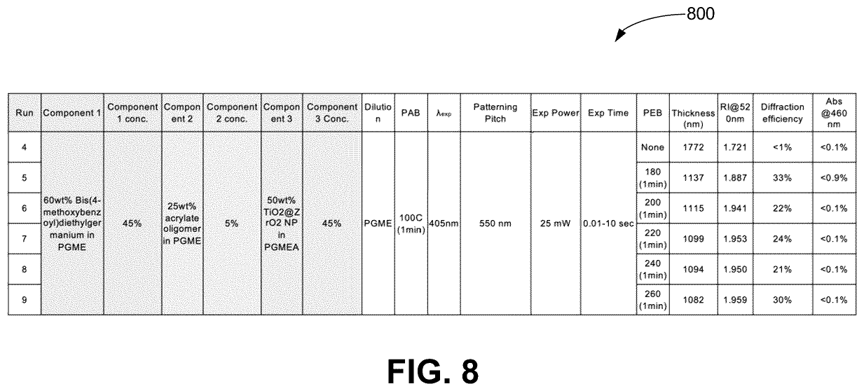

FIG. 8 includes a table 800 that illustrates working examples 4-9, presenting the components, concentrations, patterning parameters, and resulting optical properties of photo-composite coatings, according to certain aspects of the disclosure. Photo-composite coatings were deposited onto a transparent wafer via spin-coating of a suspension containing a core-shell TiO2@ZrO2 nanoparticle, an acrylate oligomer and a germanium visible light photo-reagent which can form a germanium oxide network upon photo- or thermal-degradation. The coatings underwent post-application bake at 100° C. for 1 minute to remove residual solvent. The dried samples were then photo-patterned with a 405 nm 2-beam interference source, wherein the angle between the 2 beams led to a pattern of exposure intensity with a 550 nm pitch. The formation of a diffractive pattern was only slightly apparent as the sample was photo exposed. The coatings then underwent post-exposure bake at varying temperatures, including no anneal and anneal at 180 to 260° C. Two of the samples were also subjected to changes in anneal time. The base RIs and thicknesses were determined via ellipsometry, revealing that the photo-composite formulation leads to an RI of ˜1.9 at 520 nm if the samples undergo a post-exposure bake. The efficiency of the gratings was determined by shining a 550 nm laser onto the grating pattern and measuring the intensity of all diffracted beams. It was found that the diffraction efficiency is <1% when no post-exposure bake is applied, while the fully annealed samples showed high diffraction intensity, with the values varying to some degree depending on anneal temperature and time. The transparency of the samples was determined via transmission and reflection spectroscopy, indicating that the sample was highly transparent, with an Absorption <0.1%, except for the sample annealed at 180° C., which showed increased Abs due to Haze. The grating shape was determined by STEM inspection, which showed that the gratings result from segregation of the nanoparticles away from the exposed area, and complementary accumulation of GeOx and resin in the exposed areas. The gratings appear to show a sinusoidal density distribution. Finally, the Δn of the gratings was determined for Run 7 by using a laser-based setup that measures diffraction efficiency as a function of polarization, angle of incidence, and wavelength. This relationship was extracted at 630 nm, 520 nm, and 450 nm, and the Δn was calculated by fitting the data to a model that assumes that the grating shape is sinusoidal, and which uses the base RI and thickness derived from the ellipsometry measurement. Without any diffraction response of the grants, the Δn was determined to be 0.125. This example shows that a high RI, high Δn coating can be formed with a hybrid photo-composite using visible-light and relying on a latent chemistry mechanism. The introduction of a germanium oxide network upon photoexcitation allows the photo-composite to achieve the resolution required to retain tight pitch features.

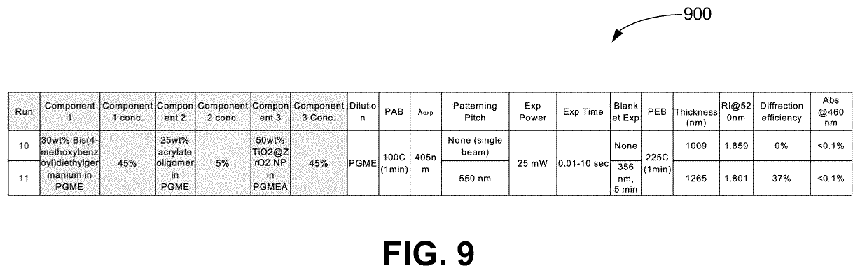

FIG. 9 includes a table 900 that illustrates working examples 10-11, showing the variations in exposure methodology and their effects on the optical properties of the coatings, according to certain aspects of the disclosure. The process used in Examples 4-9 was repeated for two samples where the exposure methodology was adjusted. In both cases, the post-exposure anneal was 225° C. for 1 minute. In Example 10, a single laser beam was used for exposure, leading to no formation of a diffractive pattern. This confirms that the latent chemistry-induced material segregation and grating formation results from the interference pattern in 2-beam exposure. In Example 11, a UV blanket exposure was applied to react the resin oligomer in both exposed and non-exposed regions. The germanium-containing photo-reagent does not react significantly upon UV exposure. As a result, the base RI of the material was reduced to ˜1.8, but the grating diffraction efficiency remained high. This indicates that in the absence of a blanket UV-cure, unreacted resin precursor is more effectively removed from the coating, leading to the higher ˜1.9 RI. However, the fact that the diffraction efficiency remains high indicates that the different germanium oxide condensation behavior between the exposed and non-exposed regions is the main driver for the generation of a compositional gradient and resulting high Δn.

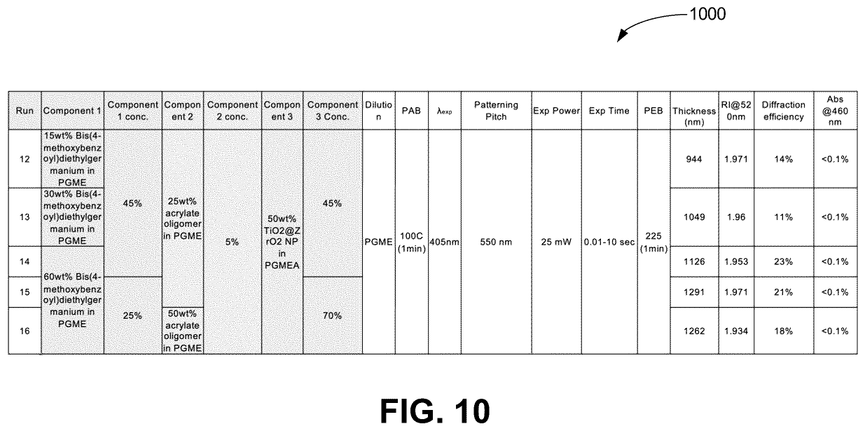

FIG. 10 includes a table 1000 that illustrates working examples 12-16, presenting the effects of varying component concentrations on the efficiency of the gratings in photo-composite coatings, according to certain aspects of the disclosure. The process used in Examples 4-9 was repeated for two samples where the loadings of each component was varied. In all, the post-exposure anneal was 225° C. for 1 minute. These examples show that the main driver for increasing the efficiency of the gratings is the relative concentration of the germanium oxide-forming photo-reagent. This supports the hypothesis that the formation of the metal oxide in the nanocomposite is the main contributor to retaining material segregation induced by photo-exposure and grating formation.

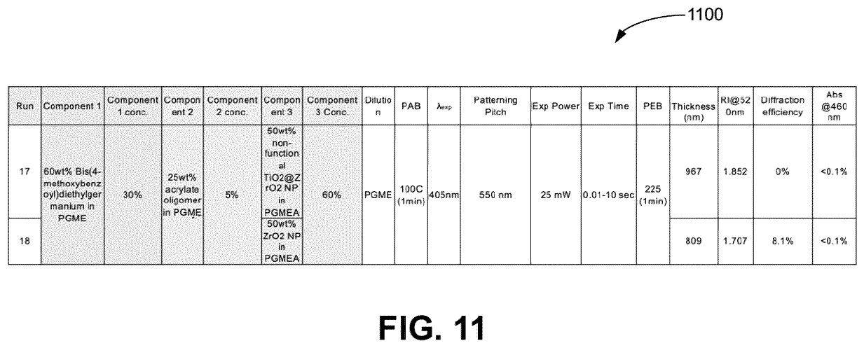

FIG. 11 includes a table 1100 that illustrates working examples 17-18, detailing the impact of nanoparticle functionality on the formation of gratings and the resulting optical properties, according to certain aspects of the disclosure. The process used in Examples 4-9 was repeated for two samples where the type of nanoparticle was varied. In all, the post-exposure anneal was 225° C. for 1 minute. In Example 17, a non-functional core-shell TiO2@ZrO2 nanoparticle without surface functionalization was utilized. It was found that no grating formation occurred. This suggests that the ability of the nanoparticles to flow and rearrange during exposure and anneal is key to the grating formation. The lack of surface functionalization drastically reduces the particle flow in the resin and germanium photo-reagent mixture, and thus the material reorganization is largely disabled. In Example 18, a ZrO2 nanoparticle is used instead, leading to a reduced base RI and Δn. This suggests that the lower Ri nanoparticle is not able to create a high RI contrast upon segregation since the particle RI is closer to the RI of the resin and germanium photo-reagent mixture, further suggesting that nanoparticle segregation is the key to driving Δn in the gratings.

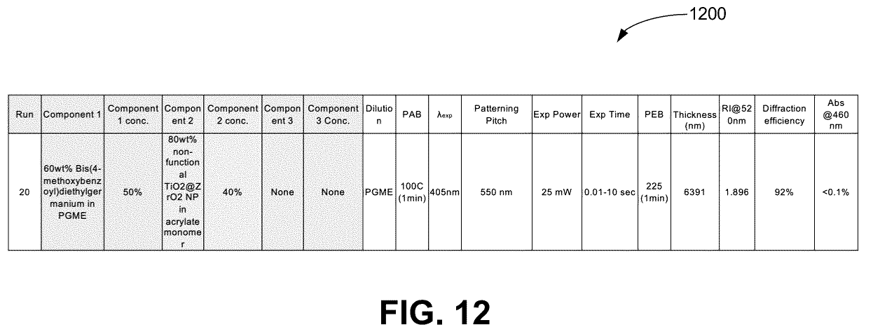

FIG. 12 includes a table 1200 that illustrates working example 20, showing the results of a high-concentration formulation for a hybrid photo-composite coating, according to certain aspects of the disclosure. The process used in Examples 4-9 was repeated using a formulation containing a higher concentration of active components. The resulting processed coating had a thickness of ˜6 μm and a base RI of ˜1.9. The diffraction efficiency increased significantly, as expected from the higher coating thickness. This example shows that high thickness, high base RI, high Δn, and visible light-reactive coatings with latent chemistry behavior can be formed with hybrid photo-composites.

The disclosed system(s) address a problem in traditional optical coating techniques for waveguide components, namely, the technical problem of achieving thick, high-RI coatings of photo-reactive materials where light-excitation leads to a local change in refractive index (RI) without causing optical artifacts or compromising image quality. The disclosed system solves this technical problem by providing a high-refractive index (RI), high (Eîn photo-patternable material via latent chemistry for recording Volume Bragg Gratings (VBGs) and holographic patterns. The disclosed subject technology further provides improvements to the functioning of AR/VR systems because it improves performance and efficiency in creating optical components with precise RI variations and minimal thickness differences, which may be useful for high-quality imaging in AR/VR applications.

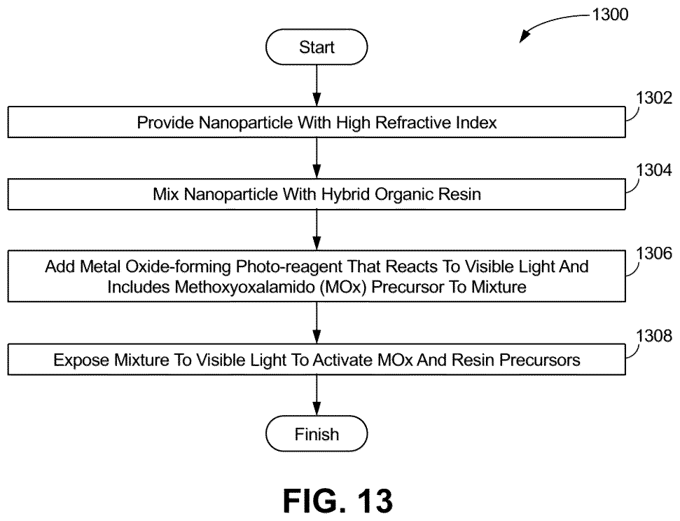

FIG. 13 illustrates an example flow diagram (e.g., process 1300) for manufacturing a patterned photo-reactive hybrid nanocomposite, according to certain aspects of the disclosure. For explanatory purposes, the example process 1300 is described herein with reference to FIG. 13. Further for explanatory purposes, the steps of the example process 1300 are described herein as occurring in serial, or linearly. However, multiple instances of the example process 1300 may occur in parallel.

A step 1302 may include providing a nanoparticle with a high refractive index. A step 1304 may include mixing the nanoparticle with a resin precursor. A step 1306 may include adding a metal oxide-forming photo-reagent that reacts to visible light to form a metal oxide (MOx) and organic radical species to the mixture. A step 1308 may include exposing the mixture to visible light to activate the MOx and resin precursors. The activated precursors may react to form an extended MOx and organic species and partially displace the nanoparticle. The nanocomposite is capable of forming a photo-pattern with a high refractive index contrast (Δn) upon exposure to visible light and subsequent annealing. For example, the high Δn may be a contrast >0.04.

According to an aspect, photo-patterning results in locally variable refractive indices that form a waveguide structure for a mixed reality device.

According to an aspect, exposure of nanocomposite leads to activation of the reagent and the organic resin precursor; and the activated reagent and the activated organic resin precursor react with each other to form an extended MOx and organic species and partially displace the nanoparticle.

According to an aspect, the nanoparticle contains a passivating metal oxide shell and phosphate, siloxane, or silicate surface species.

According to an aspect, a surface of the nanoparticle contains methacrylate or acrylate containing species.

According to an aspect, the resin is a monomer/oligomer with at least one and at most ten acrylate/methacrylate reactive sites with a high base refractive index of the polymerized resin less than 1.5.

According to an aspect, the reagent comprises a metal oxide-precursor containing a metal center decorated with photo-labile ligands and thermally labile ligands.

According to an aspect, the metal center is composed of at least one of silicon, tin, or germanium.

According to an aspect, excitation of the reagent with visible light leads to ligand scission and release of a metal species that readily forms a metal oxide upon annealing and an organic radical moiety.

According to an aspect, the nanoparticle is provided with a passivating metal oxide shell composed of at least one of phosphate, siloxane, or silicate species.

According to an aspect, the nanoparticle is surface treated with methacrylate or acrylate containing species prior to mixing with the resin precursor.

According to an aspect, the resin precursor is a monomer/oligomer with at least one and at most ten acrylate/methacrylate reactive sites and has a high base refractive index.

According to an aspect, the metal oxide-forming photo-reagent comprises a metal oxide-precursor containing a metal center decorated with photo-labile and thermally labile ligands.

According to an aspect, the exposure to visible light causes ligand scission in the reagent and releases a metal species that forms a metal oxide upon annealing and an organic radical moiety.

According to an aspect, the nanoparticle is surface treated to prevent aggregation during coating and processing.

According to an aspect, the organic resin and the activated metal oxide-forming photo-reagent forms a matrix surrounding the nanoparticles, with the matrix having locally varying amounts of MOx and organic resin depending on a photo exposure status of a local region.

According to an aspect, the nanocomposite is transparent to visible light after annealing at temperatures greater than 150° C. The thickness and RI ranges of the coating should be 1-100 micrometers thick, and the coating should have a bulk RI of at least 1.7.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects. Other variations are within the scope of the following claims.

What is claimed is:

1. A photo-reactive hybrid nanocomposite, the nanocomposite comprising:
a nanoparticle with a high refractive index;
an organic resin precursor; and
a reagent, wherein the reagent is a metal oxide-forming photo-reagent that reacts to visible light.

2. The nanocomposite of claim 1, wherein photo-patterning results in locally variable refractive indices that form a waveguide structure for a mixed reality device.

3. The nanocomposite of claim 1, wherein exposure of nanocomposite leads to activation of the reagent and the organic resin precursor, and the activated reagent and the activated organic resin precursor react with each other to form an extended MOx and organic species and partially displace the nanoparticle.

4. The nanocomposite of claim 1, wherein the nanoparticle contains a passivating metal oxide shell and phosphate, siloxane, or silicate surface species.

5. The nanocomposite of claim 1, wherein a surface of the nanoparticle contains methacrylate or acrylate containing species.

6. The nanocomposite of claim 1, wherein the resin precursor is a monomer/oligomer with at least one and at most ten acrylate/methacrylate reactive sites, wherein the refractive index of the nanocomposite is less than 1.5.

7. The nanocomposite of claim 1, wherein the reagent comprises a metal oxide-precursor containing a metal center decorated with photo-labile ligands and thermally labile ligands.

8. The nanocomposite of claim 7, wherein the metal center is composed of at least one of silicon, tin, or germanium.

9. The nanocomposite of claim 1, wherein excitation of the reagent with visible light leads to ligand scission and release of a metal species that readily forms a metal oxide upon annealing and an organic radical moiety.

10. A method of manufacturing a patterned photo-reactive hybrid nanocomposite, the method comprising:
providing a nanoparticle with a high refractive index;
mixing the nanoparticle with an organic resin precursor;
adding a metal oxide-forming photo-reagent that reacts to visible light to the mixture; and
exposing the mixture to visible light to activate the reagent and the organic resin precursor, wherein the activated reagent and the activated organic resin precursor react with each other to form an extended MOx and organic species and partially displace the nanoparticle.

11. The method of claim 10, wherein the nanoparticle is provided with a passivating metal oxide shell composed of at least one of phosphate, siloxane, or silicate species.

12. The method of claim 10, wherein the nanoparticle is surface treated with methacrylate or acrylate containing species prior to mixing with the hybrid organic resin.

13. The method of claim 10, wherein the organic resin precursor is a monomer/oligomer with at least one and at most ten acrylate/methacrylate reactive sites and has a high base refractive index.

14. The method of claim 10, wherein the metal oxide-forming photo-reagent comprises a metal oxide-precursor containing a metal center decorated with photo-labile and thermally labile ligands.

15. The method of claim 14, wherein the metal center is composed of at least one of silicon, tin, or germanium.

16. The method of claim 10, wherein the exposure to visible light causes ligand scission in the reagent and releases a metal species that forms a metal oxide upon annealing and an organic radical moiety.

17. A photo-reactive hybrid nanocomposite for use in high-efficiency waveguide gratings, the nanocomposite comprising:
a nanoparticle with a high refractive index;
an organic resin precursor; and
a metal oxide-forming photo-reagent that reacts to visible light,
wherein the nanocomposite is capable of forming a photo-pattern with a high refractive index contrast (Δn) upon exposure to visible light and subsequent annealing.

18. The nanocomposite of claim 17, wherein the nanoparticle is surface treated to prevent aggregation during coating and processing.

19. The nanocomposite of claim 17, wherein the organic resin and the activated metal oxide-forming photo-reagent form a matrix surrounding the nanoparticles, with the matrix having locally varying amounts of MOx and organic resin depending on a photo exposure status of a local region.

20. The nanocomposite of claim 17, wherein the nanocomposite is transparent to visible light after annealing at temperatures greater than 150° C.
